(19) United States
(12) Patent Application Publication
(10) Pub. No.: US 2006/0016270 A1
(43) Pub. Date: Jan. 26, 2006

(54) Load sensor

(76) Inventors: Roberto Cavenago, Paderno Dugano (IT); Massimo Gherlinzoni, Monza (IT)

Correspondence Address: David George Johnson, Post Office Box 286, Aitkin, MN, 56431, US

(21) Appl. No.: 11/181,452

(22) Filed: Jul. 13, 2005

(30) Foreign Application Priority Data
Jul. 14, 2004 (EP) 04425523.0

(51) Int. Cl. G01N 3/08

(52) U.S. Cl. 73/818

(57) ABSTRACT

The present invention relates to a load sensor provided with a structure (4, 5, 94, 95) deformable in relation to the weight (P) of a load applied to an element thereof. A load cell supplies an electrical signal which is a function of the stress transmitted thereto by the structural element (2, 92) to which the weight is applied. The structural elements (1, 2, 91, 92) composing the structure of the load sensor are produced with plates or sections made of metal such as stainless steel without the use of welds.

### FIELD OF THE INVENTION

The present invention relates to a load sensor, in particular to a load sensor used to measure the weight of both static and moving loads.

### BACKGROUND OF THE INVENTION

Several different types of load sensing devices are available on the market. Some sensors provide measurement of the weight of static loads, others provide measurement of the weight of moving loads and yet others still are suitable to measure the weight of loads both static and moving with respect to the measuring device. The invention relates to this last category of load sensing devices. Some traditional sensors of this last type use transducers capable of producing an electric signal as a function of the amount of stress (compression and/or traction and/or bending) to which they are subjected. Among the most widely used transducers are load cells.

For example, U.S. Pat. No. 5,337,618 relates to a load sensor, used in particular to measure the weight of a load moved by a conveyor belt, provided with a structure that is deformable in response to the weight to be measured. The deformable structure receives stress from the conveyor belt and transmits only the vertical component of this stress to a load cell. The cell is then loaded and provides an electric signal which is a function of the amount of bending and, consequently, of the weight applied to the sensor. The load sensor can be coupled, by means of screws, to preexisting movement systems.

Conventional load sensors, equivalent or similar to the sensor in U.S. Pat. No. 5,337,618 have a series of drawbacks. In the first place, the structural elements of known sensors are, in general, bulky and heavy. Consequently, the load sensors as a whole are bulky and heavy and therefore difficult to handle, with evident negative effects on the time required to install the sensors in the systems or machinery with which they must be associated. The structural elements are generally produced by aluminium casting. Further processing, such as, for example, drilling, filing and surface machining is therefore required on these elements to complete the assembly of the sensor. Specialized technicians are often required to perform the finishing processes, thereby causing an increase in the production costs of the sensor. Moreover, any errors in the finishing operations increase the possibilities of breakage of the structural elements. For example, imprecise drilling, or drilling performed at unsuitable points on a given structural element can jeopardize the mechanical resistance and cause yielding when the element is subjected to stress.

Many conventional load sensors, such as those provided with aluminium structural elements cannot be used in systems for the processing of biodegradable or food substances. In fact, current regulations in many countries require that machinery used to treat these types of substance must be subjected to frequent washing with detergents, for example with high pressure jets of a mixture of water and aggressive detergents. Aluminium, typically used to produce load sensors installable on preexisting machinery, can in fact be corroded by detergents and promotes modification of the biodegradable substances deposited in contact therewith.

For moving load applications, specific steel load sensors of large dimension are known which are incorporated into the overall load moving systems. Typically, these load sensors are provided with a fixed frame, integral with the structure of the system to move the substances and having essentially the same overall dimensions as the rest of the load moving system, and having a movable frame hinged thereto. The movable frame transfers the stresses of the moving system, for example a conveyor belt, to a load cell. This type of sensor requires a specific design so that each sensor is compatible with the moving system with which it is to be associated only and an existing machine cannot typically be retrofitted with a standard load sensor.

### SUMMARY OF THE INVENTION

The present invention is intended to provide an improvement with respect to existing load sensors by addressing in a simple and inexpensive way the drawbacks associated with conventional load sensors. The present invention provides a load sensor that is relatively compact, lightweight and easy to handle and which can be installed on pre-existing equipment even if this equipment is to be used in the processing of food or biodegradable substances. The present invention is directed to a load sensor which is relatively simple to maintain and which is readily subjected to hygienic treatments when installed on equipment.

The load sensor of the present invention provides for two structural elements formed of bent metal sheets or drawn metal that are connected by means of two or more blades such as, for example, lamina or flexible elements that connect upper and lower engaging portions of the structural elements. The engaging portions of one of the blades, preferably of the blade that is lower with respect to the load, are at least in part superimposed and spaced apart along a vertical plane of the sensor assembly.

The load sensor of the present invention can be used both as a weight measuring device such as a weighing scales for static loads, and as a weight measuring device for moving loads. In the first case, the load is static and is applied directly to the second structural element. In the second case the load is in movement with respect to the second structural element. The sensor reads the weight of a load which at a given instant is moved by a belt that abuts, while running, the top of the second structural element.

Advantageously, the load sensor according to the present invention has two structural elements made of bent metal sheets, which can be constructed as plates or drawn metal pieces such as structural sections or bars without welds and can therefore achieve a much greater rigidity than conventional structural elements produced by aluminium casting. Moreover, the plates or sections are extremely simple to handle and allow considerable reduction in the time required to assemble the load sensor with respect to the time required for assembling conventional structural elements. Furthermore, the structural elements of the load sensor of the invention do not require further processing and/or machining, but can be assembled directly, with resulting savings in time and costs. For example, the plates or sections can be produced with the bores required for assembly and installation of the sensor. Moreover, the size of the load sensor for a given weight range is less than the size of corresponding conventional sensors.

The first structural element and the second structural element are shaped so that, when they are coupled together, the portions of the flexible elements coupled to the first structural element are fixed. The portions of the flexible elements coupled to the second structural element move within a vertical plane by substantially the same amount. According to one embodiment of the present invention, at least one structural element has a substantially C-shaped profile within a vertical plane. According to another embodiment of the invention one or both structural elements have lateral walls. According to a further embodiment of the invention one structural element has an S-shaped profile within a vertical plane.

A first flexible element such as a blade connects the two lower engaging portions. A second flexible element couples together the upper portions of the first and of the second structural element. The first and the second flexible element are mounted parallel to each other, while the first and the second structural elements are coupled in an opposed relationship. Being elastically deformable, the flexible elements allow the second structural element to move solely in a direction parallel to the first structural element. When the sensor is not stressed by a weight, the flexible elements return the second structural element to its initial position.

The load sensor may have one or more spacers made of metal, interposed between the structural elements and the flexible elements. The spacers allow a simple assembly of the load sensor, so that the lower and upper portions of the two structural elements are essentially parallel when the flexible elements are not subjected to bending stress by the load applied to the second structural element.

In one embodiment of the present invention, the lower blade is external and directly mounted on the engaging portions. To obtain this arrangement, the lower engaging portion of the first, fixed structural element is provided with an extension having a vertical and a horizontal part that eliminates the need to use a spacer. The other corresponding engaging portion of the second, vertically moving structural element is a block extending between the two lateral walls or sides of the second structural element. The block is at the same level as the horizontal part of lower engaging portions of the first structural element.

Preferably, the structural elements are made of a metal. In this case the metal used to manufacture the structural elements, and optionally the spacers, can be steel. The steel is preferably stainless steel, according to standard AISI 304 or standard AISI 400. Alternatively, the metal can be any type equivalent to stainless steel. According to a preferred aspect of the present invention, the flexible elements are annealed steel sheets obtained through laser cutting processes.

The metal is preferably resistant to detergents, solvents and to jets of pressurized fluids. This characteristic allows the production of load sensors responding to the strict hygiene regulations for food processing systems. The load sensors of the present invention can be washed with the detergents normally used in the field, including pressurized jets of detergent fluids. The metal is appropriately chosen so that it does not promote modifications of biodegradable substances that may have been deposited on the sensor. The load sensor can also be used in industrial settings other than those relating to the processing of biodegradable substances. For example, the load sensor can be used in systems for moving and/or processing materials of various types, such as coal, gravel, sand, or other particulate matter.

Further features of the invention shall become apparent and evident from the detailed description of a preferred, although non-exclusive, embodiment, of a load sensor constructed according to the principles of the present invention, shown as a non-limiting example, in the attached drawings.

### BRIEF DESCRIPTION OF THE DRAWINGS

FIG. 1 is a perspective view of a sensor according to the invention;

FIG. 2 is a side view of the sensor in FIG. 1;

FIG. 3 is a sectional view of the sensor in FIG. 2, as viewed along the line A-A;

FIG. 4 is a top view of the sensor in FIG. 1;

FIG. 5 is a bottom view of the sensor in FIG. 1;

FIG. 6 is a front view of the sensor in FIG. 1;

FIG. 7 is a rear view of the sensor in FIG. 1;

FIG. 8 is a side view of the sensor in FIG. 1 fitted to an external body and subject to a weight P;

FIG. 9 is a perspective view from below of another embodiment of the invention;

FIG. 10 is a perspective view from above of the embodiment of FIG. 9; and

FIG. 11 is a sectional view along a vertical plane of the embodiment depicted in FIG. 9.

### DETAILED DESCRIPTION OF THE INVENTION

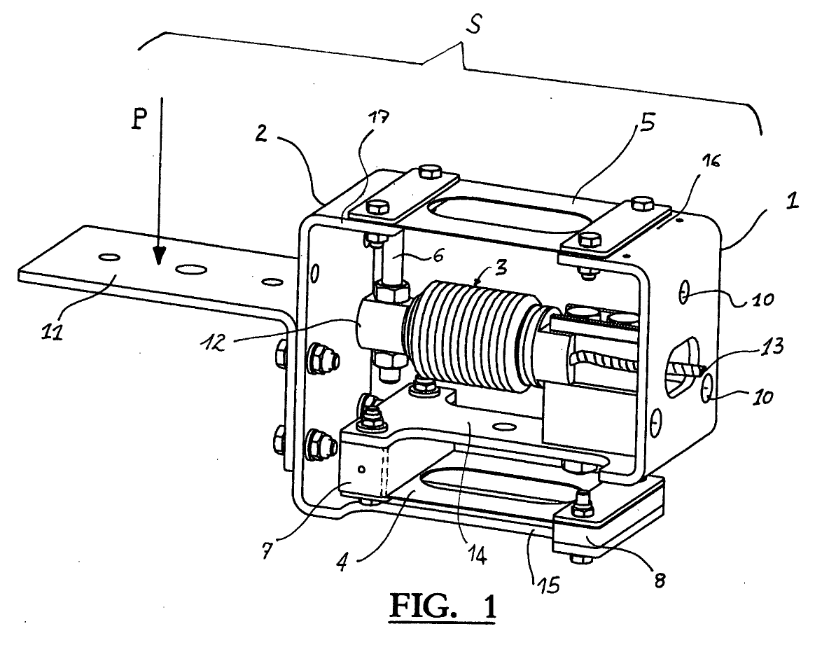

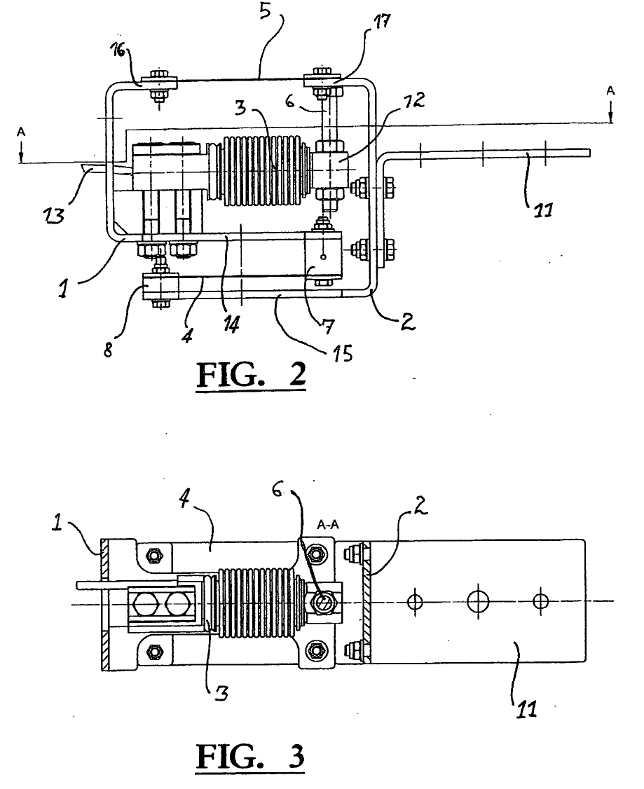

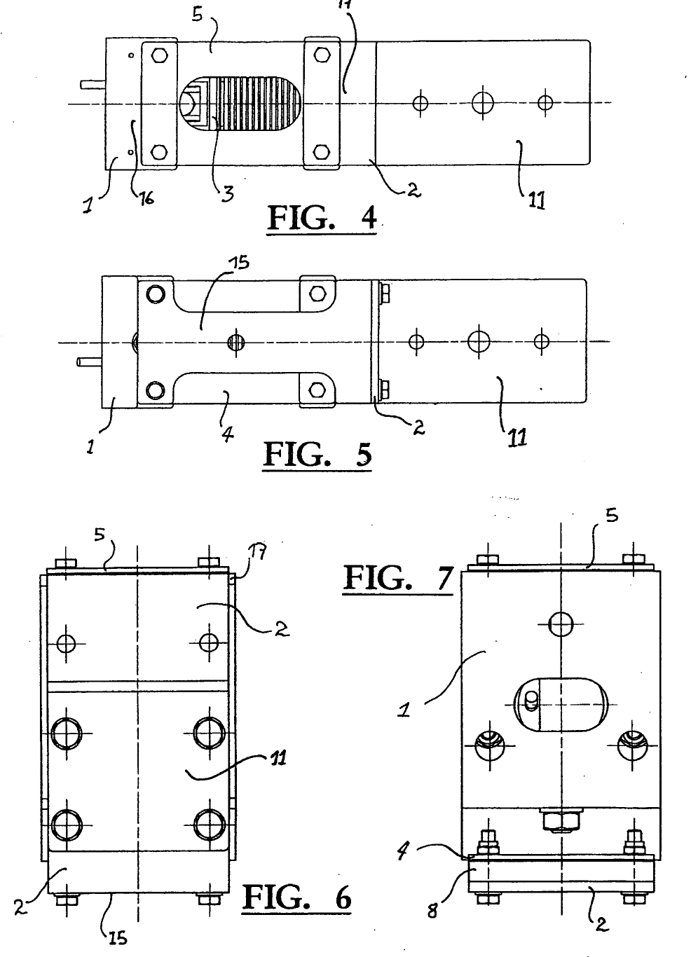

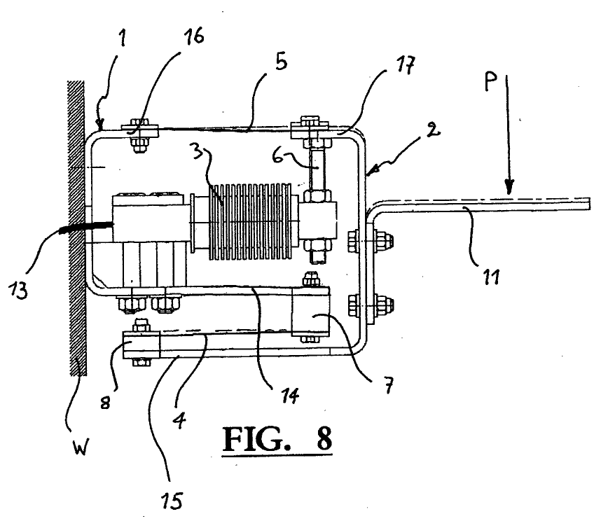

FIGS. 1-7 depict a first embodiment of the load sensor constructed according to the principles of the present invention. The sensor comprises a first rigid structural element 1 and a second rigid structural element 2 coupled to the first element 1 in a movable way in response to the weight of a load to be measured that is transmitted to the second element 2. In the embodiment shown, the load sensor S comprises a first rigid structural element 1, connectable to a supporting body W (FIG. 8), and a second structural element 2, also rigid, coupled to the first element 1 by flexible means such as by blades 4 and 5. The structural elements 1 and 2 are constructed from one or more bent plates or metal sections.

The element 1 is coupled to an external supporting body, for example the frame of a conveyor belt, by means of screws, bolts and nuts or equivalent means. For this reason element 1 is provided with mounting holes 10 that are formed during the production process. The element 2 will be stressed, directly or indirectly, by the weight P of a load to be measured. In the embodiment shown, element 2 is associated with a shelf 11 attached thereto. When sensor S is set up, the shelf 11, or alternatively a portion of the structural element 2, is loaded with the weight P which may be of the static type or may be variable over time. In the case of a variable load, a conveyor belt which moves a load of flour, gravel, coal, or other material will be in contact with shelf 11.

The element 2 is connected to element 1 by means of at least two flexible elastic elements. In the embodiment shown the flexible elements are two blades 4 and 5. When a weight, represented by the vector P, acts on the structural element 2, blades 4 and 5 are elastically deformed by bending and allow element 2 to move with respect to the element 1 solely within a vertical plane, for example on a plane orthogonal to the upper surface of the shelf 11. This vertical plane contains the vector P and the axis of the load cell 3. For example, element 2 can move within the vertical plane along a direction parallel to the direction of the weight P. When element 2 is not subjected to stresses, blades 4 and 5 return element 2 to its initial position.

The load cell 3 is integral with the first structural element 1 and is stressed by element 2 when the latter is subjected to weight P. In the shown embodiment, the load cell 3 is cantilevered and coupled with element 1, having a free end 12 facing element 2. Connected to the end 12 is a feeler 6 which has the function of transmitting the movements or displacements of the structural element 2 to the load cell 3. The feeler 6 generates an electric signal proportional to the magnitude of the measured displacement. The electric signal is sent through cable 13.

Structural elements 1 and 2 have, within a vertical plane, a C-shaped profile. The lower portion of structural element 1 is referred to with reference number 14, while the lower portion of structural element 2 is indicated with reference number 15. These lower portions form the engaging portions for the lower blade. The elements 1 and 2 shown in FIG. 1 have an asymmetrical C-shaped profile, as the lower portion 14, 15 of each structural element 1 or 2 is longer than the corresponding upper portion 16, 17. The lower portions that are the engaging portions 14 and 15 for blade 4 can have different shapes from those shown in FIGS. 1-8 and can engage directly or indirectly through a spacer the blade 4.

As can be seen, elements 1 and 2 are opposed. The engaging portions 14 and 15, coupled by means of the blade 4, are partially superimposed, while the upper portions 16 and 17, coupled through the blade 5, face each other. Due to this configuration, when a weight P is applied to the sensor S, the blades 4 and 5 bend in opposite directions and the structural element 2 is guided to move parallel to the structural element 1, as shown in FIG. 8. FIG. 8 shows the sensor S integral with a surface W and subjected to a load P. The dashed lines indicate the position at rest of the components of the sensor S with respect to the position induced by the load P. The lower, engaging portions 14 and 15 can be completely superimposed, that is superimposed for their entire extension, or partly superimposed, depending on their shape, the type of blade with which they are coupled, and related factors.

The load sensor S represented in FIGS. 1-8 comprises two spacers 7 and 8 having the function of facilitating assembly of the sensor S, in particular with regard to establishing the parallel relationship of the structural elements 1 and 2. Alternatively, the elements 1 and 2 can be suitably bent. The spacer 7 has the function of separating the lower portions 14 and 15 on a vertical plane, preferably along the vertical direction relative to the movement of the structural element 2. Alternatively, the lower engaging portions 14 and 15 can have one end with a shape functionally equivalent to the shape of the spacer 7.

The shape of structural elements 1 and 2 can be different depending on the use for which the sensor S is intended. For the same reasons, the sensor S can be equipped with other blades besides those 4 and 5 provided in the embodiment shown. For example, the sensor S can be provided with two parallel pairs of blades, an upper pair and a lower pair.

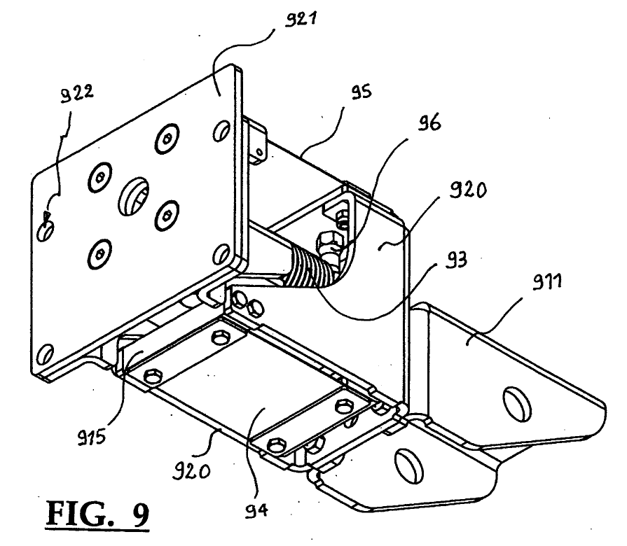

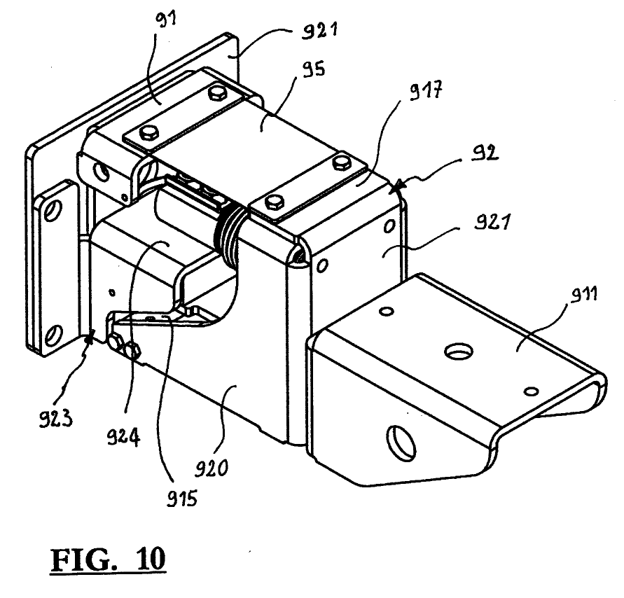

FIGS. 9, 10 and 11 show an embodiment for use with heavy weights. In this embodiment the numerical references are similar to those used in FIG. 1-8 with the numeral 9 as a prefix. The embodiment of FIGS. 9-11 is made of metal sheets cut and bent, without any welding. More particularly, the upper portions 916 and 917 of the two structural elements 91 and 92 of sensor S′ are shaped identically to corresponding upper portions 16 and 17 of the previously discussed sensor S. A blade such as a lamina or flexible element 95 extends from portion 916 to portion 917 and is secured to portion 917.

Structural element 91 is provided with a lower portion 914 that, as in sensor S, extends substantially parallel to the upper portions 916 and 917 so that upper portion 917 is partly superimposed onto lower portion 914. Lower portion 914 corresponds to portion 14 of the previously disclosed embodiment and is the engaging portion for the lower blade or lamina 94. Portion 914 is provided with an integral extension having a vertical part 918 and a horizontal part 919 that replaces or eliminates the need for a spacer.

Structural element 92 has no horizontal lower portion, the lower portion having been replaced by two sides, namely the lateral walls 920 and a block 915 transversely extending between the two side walls 920. Side walls 920 are preferably integrally formed with the upper portion 917 and front portion 921, having an L-shape and extend laterally to a position that is below the upper portion 916. At the end of walls 920 block 915 is secured to the walls 920 to provide the lower engaging portion 915 for blade 94. Due to this arrangement the lower blade 94 is external to engaging portions 919 and 915, resulting in a relatively easier and quicker assembly of the sensor. As in the embodiment of FIGS. 1-8, engaging means 915 of second element 92 is positioned below both lower and upper engaging means 914 and 916 of first element 91. Lower engaging means 914 and extension 918-919 are located below upper engaging means 917 of second element 92.

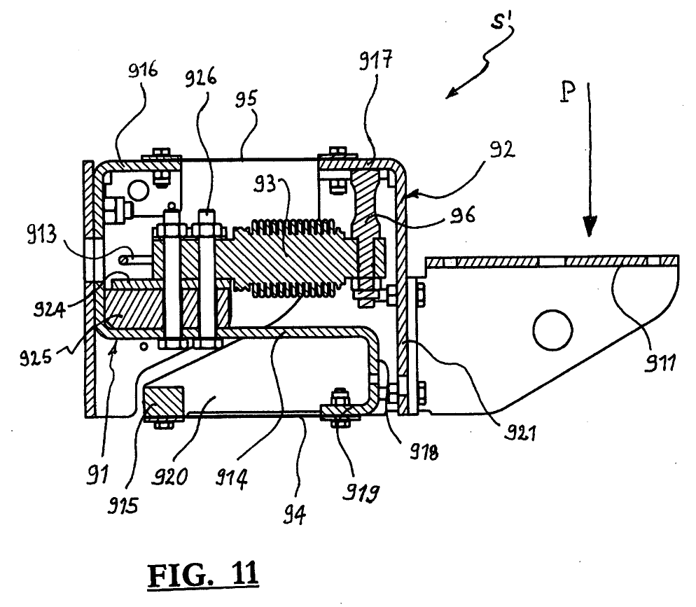

To further reinforce the structure, element 91 is secured by bolts and nuts to a base plate 921 that is provided with means such as bores 922 for being attached to the final apparatus. On plate 921 is provided a bent element 923 that extends from one side to the other side of the sensor and includes a flat horizontal portion 924 on which is positioned the load cell 93. As shown in FIG. 11, a block 925 is located between flat part 924 and the portion 904 of structural element 91. Load cell 93 is secured to element 91 together with element 923 and block 925 by means of bolts and nuts 926.

Sensor S′ operates in the same way as sensor S. When a load P is applied to the shelf and thus to the load supporting member 911, blades 95 and 94 flex and only the normal forces that are applied to the structure are transmitted to cell 93 by feeler 96.

Preferably, all the components of the invention sensor are made of metal. In order to satisfy the requirements of health and hygiene regulations relative to systems for the processing of food or biodegradable substances, or the like, the metal is preferably steel. For example, structural elements, spacers, blocks and additional elements can be produced in stainless steel of the type corresponding to the standard AISI 304 or to the standard AISI 400. The blades 4 and 5 can be obtained from laminates in annealed steel, through laser cutting processes. Any screws and bolts are also preferably made of stainless steel.

The blades 4, 5, 94 and 95 have a preferred thickness within the range of 0.1 to 1.0 mm. Thanks to the use of steel plates or sections, the structural elements can be very compact, without reducing the performances of the sensor. In one embodiment the sensor is approximately 150 mm long, approximately 120 mm high and approximately 70 mm wide. The load cell 3, 93 can be of different types according to the uses for which the sensor is intended. In one embodiment the cell 3 is of the SHB type and has a sensitivity of 9±0.02 mV, with a precision class given by 3000 divisions.

The sensor of the present invention can measure the weight of variable loads within the range from 5 to 200 kg. While the average industrial application is for ranges of 20 kg to 50 kg, the sensor can be set to measure weights much larger or much smaller than these values. For example, the sensor can be used to measure the weight of a load of coal being moved on a conveyor belt. In this case the sensor will be associated with a roller station of the moving system and will be provided with a load cell that is adapted to measure substantial weights, for example on the order of 200 kg. When the sensor is used to measure the weight of a lighter load, the load cell will hove different specifications and will be adapted to measure smaller weights, for example on the order of 5 kg.

The sensor S, S′ may be installed on pre-existing machinery without the need for specialized technicians. The sensor can be sold directly to the end user who can perform the installation without assistance due to the simple construction, light weight and reduced dimensions of the sensor. The sensor can be used both in conventional sectors such as moving materials like stones, coal and gravel, and in those sectors relating to the processing of food or biodegradable substances without the necessity of modifying one or more parts of the sensor to adapt it to the different needs of the various systems.

1. A load sensor of the type comprising:
a first rigid structural element (1, 91), securable to an external body; a second rigid structural element (2, 92) connected to said first structural element (1, 91) through at least two flexible elements (4, 5, 94, 95), said second structural element (2, 92) being movable with respect to said first structural element (1, 91) within a substantially vertical plane in response to the weight (P) of a load to be measured being transmitted to said second structural element (2, 92);
a load cell (3, 93) secured to said first structural element (1, 91) and functionally associated with said second structural element (2, 92), said load cell supplying an electrical signal which is a function of the stress transmitted by said second structural element (2, 92);
characterized in that said first structural element (1, 91) and said second structural element (2,92) are produced with plates or sections, and a first flexible element (4,94) of said at least two flexible elements (4, 5, 94, 95) is coupled to corresponding engaging portions (14, 15, 914, 915) of said first (1, 91) and of said second (2, 92) structural element, said engaging portions (14, 15, 914, 915) being at least in part superimposed and spaced apart along said essentially vertical plane.

2. A load sensor as claimed in claim 1, characterized in that said first structural element (1, 91) and said second structural element (2, 92) are shaped so that, when coupled, the portions of said at least two flexible elements coupled to said first structural element (1, 91) are fixed and the portions of said at least two flexible elements coupled to said second structural element (2, 92) move within said vertical plane essentially by the same amount.

3. A load sensor as claimed in claim 2, wherein a second flexible element (5, 95) of said at least two flexible elements (4, 5, 94, 95) couples together the substantially opposed upper portions (16, 17) of said first (1, 91) and of said second (2,92) structural element, said first flexible element (4,94) and said second flexible element (5,95) being mounted in a substantially parallel relationship, said first structural element (1,91) and said second structural element (2,92) being coupled together in a substantially opposed relationship.

4. A load sensor as claimed in claim 3, wherein said first structural element (1) and said second structural element (2) have within said vertical plane a substantially C-shaped profile.

5. A load sensor as claimed in claim 4, wherein at least one metal spacer (7, 8) is located between said first flexible element (4) and each of said first and second structural elements (1, 2).

6. A load sensor as claimed in claim 1, wherein said lower engaging portion (914) of said first structural element (91) is provided with an extension (918, 919) to which said flexible element (94) is secured, said second structural element (92) comprising side walls (920) and lower engaging portion comprising a block (915) transversely extending between said side walls (920).

7. A load sensor as claimed in claim 1, wherein said first and second structural elements (1, 2, 91, 92) are made of steel.

8. A load sensor as claimed in claim 1, wherein said metal is resistant to detergents, solvents and to jets of pressurized fluids.

9. A load sensor as claimed in claim 7, wherein the steel is stainless steel according to standard AISI 304 or AISI 400.

10. The load sensor of claim 7, wherein said flexible elements (4, 5, 94, 95) are annealed steel blades obtained through laser cutting processes.

11. The load sensor of claim 2, wherein said load cell (3, 93) is cantilever coupled to said first structural element (1, 91), in correspondence to its central portion, parallel to its lower (14, 914) and upper (16, 916) portions, and is provided with a feeler (6, 96) suitable to transfer the stresses transmitted to said second structural element (2, 92) to the load cell (3, 93).
